(19) United States
(12) Patent Application Publication
(10) Pub. No.: US 2005/0211187 A1
(43) Pub. Date: Sep. 29, 2005

(54) Control station with integrated collar recharging docking station for pet electronics products

(76) Inventors: Larry L. Harman, Abbottstown, PA (US); Julia Brittain-Hulyo, Lititz, PA (US); Edward J. Holliday, Lititz, PA (US)

Correspondence Address: JACOBSON HOLMAN PLLC, 400 SEVENTH STREET N.W., SUITE 600, WASHINGTON, DC, 20004, US

(21) Appl. No.: 11/078,486

(22) Filed: Mar. 14, 2005

Related U.S. Application Data
(60) Provisional application No. 60/552,192, filed on Mar. 12, 2004.

(51) Int. Cl. A01K 15/04

(52) U.S. Cl. 119/721

(57) ABSTRACT

An improved control station powered through an AC/DC converter is provided for use in conjunction with a buried boundary wire to provide a fence-free animal containment system. The control station has a transmitter unit that transmits a signal through the underground wire to determine the pet's boundary, and further includes a battery recharging docking station integrally formed therewith that receives the corresponding collar/receiver assembly worn by the animal when battery recharging of the receiver is necessary. Through the built-in docking station, the control station provides convenient collar battery recharging capability while efficiently using the same AC/DC converter unit that powers the control station transmitter unit.

This application is entitled to and hereby claims the priority of co-pending U.S. Provisional application Ser. No. 60/552,192 filed Mar. 12, 2004.

### BACKGROUND OF THE INVENTION

1. Field of the Invention

The present invention is related to the field of pet electronics products and, more particularly, to a control station with integrated collar recharging docking station for a fence-free pet containment system.

2. Description of the Related Art

As an alternative to the establishment of a yard perimeter using conventional fencing materials suitable for animal containment, fence-free pet electronics products have been developed which use a control box that transmits a signal through underground wires to a collar unit that is worn by a pet. The collar receives the signal from the boundary wire and administers an electrical stimulus when necessary. In this manner, an underground containment boundary is defined for the pet that effectively retains the animal within the designated area, but without any visible fencing above ground. Such a system is described in co-pending U.S. patent application Ser. No. 10/989,101, filed on Nov. 16, 2004, the disclosure of which is hereby expressly incorporated by reference as though set forth herein in its entirety.

Current control boxes provide output signals, determine signal levels, and illustrate system conditions. Such units are generally powered using an AC/DC converter plugged into a household outlet. The collar units use rechargeable batteries which must be separately recharged as necessary. As a result, the user must obtain the control box and, in addition, must utilize a separate AC/DC converter to recharge the collar batteries. This can be inconvenient and complicates use and maintenance of the electronic pet containment system.

### SUMMARY OF THE INVENTION

In view of the foregoing, one object of the present invention is to simplify the process by which the collar and the fence are kept operational through a unified control station that not only provides the necessary control information to monitor the output of the perimeter fence but which also provides increased convenience and simplicity for the user.

Another object of the present invention is to provide a control station having additional features that reduce the number of components necessary through the dual usage of a single AC/DC converter for both powering of the control station and recharging of the collar battery.

A further object of the present invention is to provide a transmitter unit for use with an underground boundary wire that has a collar battery recharge port embedded therein.

In accordance with these and other objects, the present invention is directed to a control station for use in conjunction with a boundary wire that is preferably buried to provide a fence-free animal containment system. The control station, having a transmitter unit that transmits a signal through the underground wire to determine the pet's boundary, supplies an output signal, determines the signal level and thereby the boundary width, and illustrates the operating condition of the unit. The control station further includes a battery recharging docking station that receives the collar/receiver assembly worn by the animal and recharges the battery therein using the same AC/DC converter unit that powers the control station transmitter unit.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a front view of the control station showing the battery charge port and collar/receiver assembly support shelf in accordance with the present invention;

FIG. 2 is a perspective view of the receiver unit showing the battery recharge port with protective cover;

FIG. 3 is a block diagram illustrating the transmitter and receiver units with power units in accordance with the present invention;

FIG. 4 is a front view of the control station of FIG. 1, shown with the collar/receiver assembly mounted on the collar/receiver assembly support shelf;

FIG. 5 is a side view of the control station and collar/receiver assembly of FIG. 4;

FIG. 6 is a perspective view of the control station and collar/receiver assembly of FIG. 4;

FIG. 7 is a schematic of the control station transmitter showing the charge jack for the collar assembly incorporated therein, in accordance with the present invention; and

FIG. 8 is a schematic of the collar assembly receiver, in accordance with the present invention.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

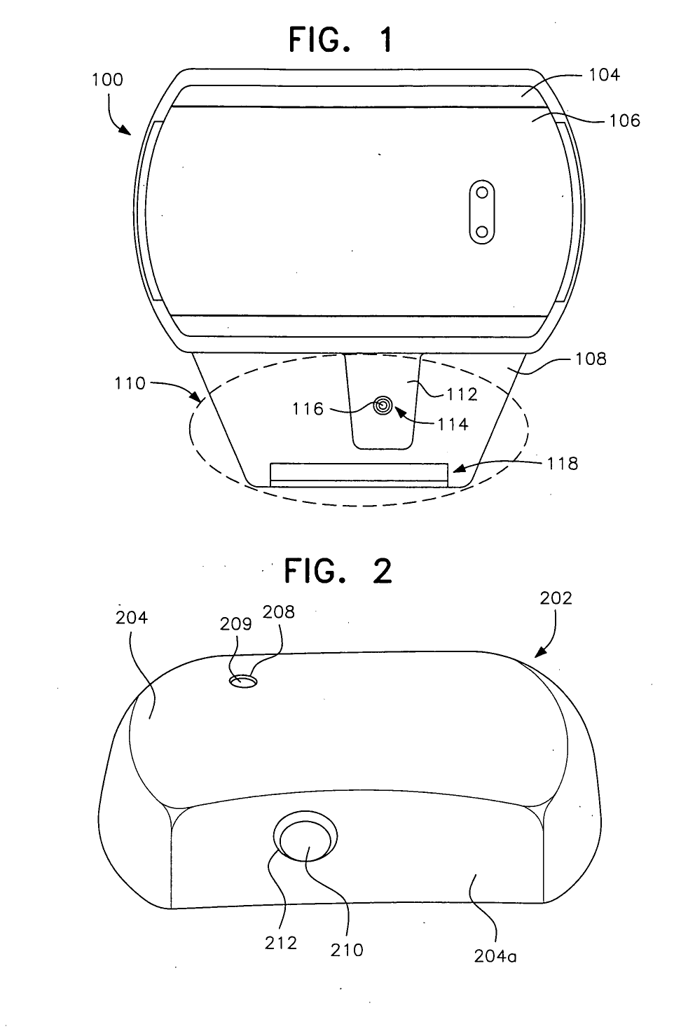

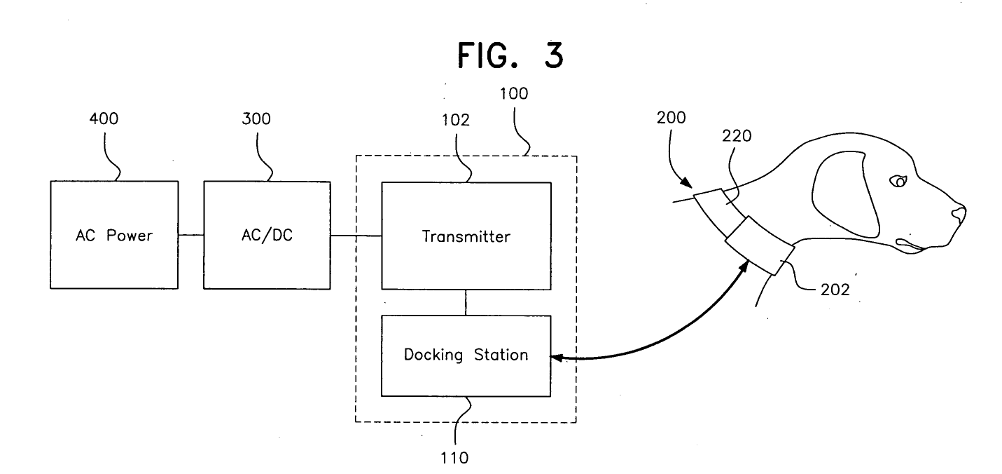

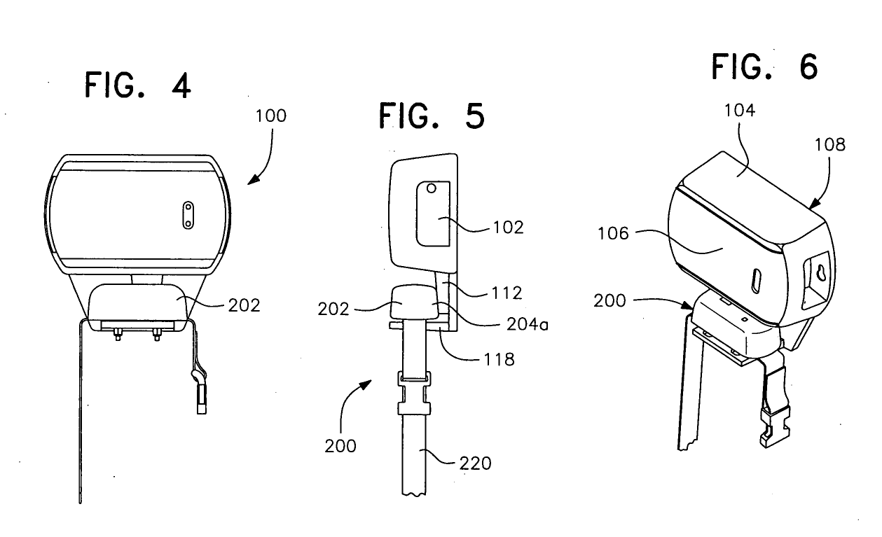

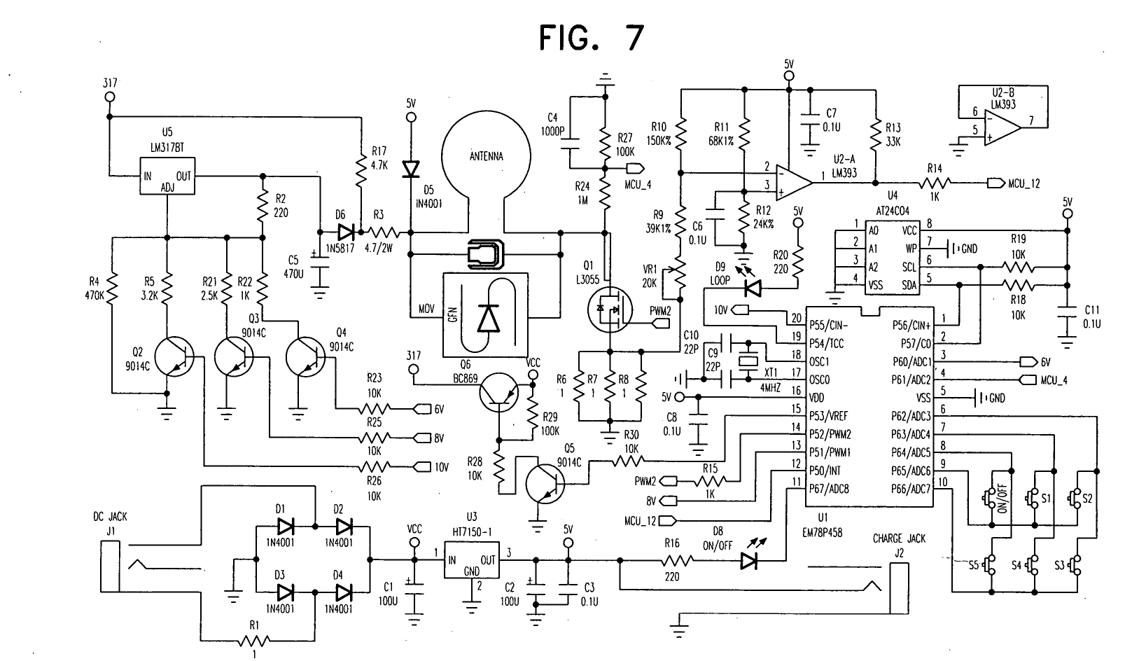

As shown in FIGS. 1-6, the electronic pet containment system in accordance with the present invention includes a control station, generally designated by the reference numeral 100, and a collar/receiver assembly, generally designated by the reference numeral 200. Both the control station 100 and the collar/receiver assembly 200 are powered and recharged, respectively, through a single AC/DC converter 300 that is coupled to an AC power source 400.

The control station 100 includes a transmitter unit 102 protected within a housing 104 having an access door 106 therein for entering the housing 104. The housing 104 is mounted on a back plate 108 that extends downwardly beyond the rear housing perimeter to form a vertical back support for the docking station 110. Generally parallel with and supported upon the vertical back plate 108 is a battery charge port arm 112 having a battery charge port 114 with a plug 116 therein that is electrically coupled with the transmitter unit 102.

Projecting generally perpendicularly from the lower edge region of the vertical back plate 108 is a collar/receiver assembly support shelf 118. The shelf is wide enough for secure placement of the collar/receiver assembly 200 thereon during recharging operations.

The collar/receiver assembly 200 includes a receiver unit 202 and a rechargeable battery (not shown) protected within a housing 204. Through a generally circular aperture 208 in the housing, a light emitting diode 209 provides a visual indication of battery charge status. A side surface 204a of the housing 204 is provided with a battery recharge port 210 that is fitted with and protected by a cover 212 when the receiver unit is not in the process of recharging.

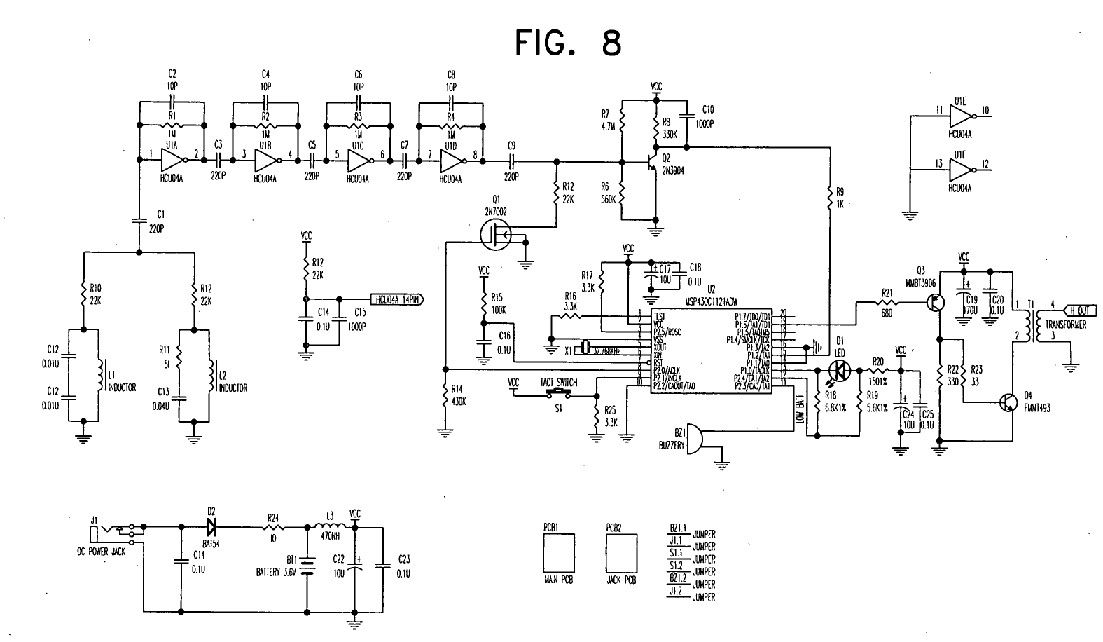

The receiver unit 202 is fitted onto a collar 220 to form the collar/receiver assembly 200. When recharging of the collar/receiver assembly 200 is necessary, the cover 212 is removed from the receiver housing 204 to expose the battery recharge port 210. The receiver unit 202 is then placed on the collar/receiver assembly support shelf 118 with the side surface 204a facing the battery charge port arm 112 and the port 210 is mounted on the recharge plug 116 of the docking station 110. The battery of the receiver unit 202 is then recharged by the DC power being provided to the control station via the AC/DC converter unit 300. Details of the transmitter and receiver circuits are shown in the schematic drawings of FIGS. 7 and 8, respectively.

In use, the AC/DC converter 300 is plugged into a household wall outlet or other 120V AC power source 400. The power plug of the converter (not shown) is plugged into the control station in the usual manner as is known in the art, and the transmitter unit is turned on. The control station 100 then operates in a normal manner to indicate the operating condition of the unit, e.g., the ON/OFF status and the LOOP condition relative to the boundary wire. The control station also supplies the output signal to the underground boundary wire (not shown) and determines the signal level which, in turn, determines the width of the boundary. The receiver unit 202, when coupled with the collar 220 being worn by the pet, supplies the appropriate electrical stimulus to the pet to indicate boundary wire proximity. This is explained in greater detail in co-pending patent application Ser. No. 10/989,101, previously incorporated by reference herein.

When recharging of the receiver unit 202 becomes necessary, the collar/receiver unit assembly 200 is removed from the pet, as indicated by the arrowed line in FIG. 3. The recharge port cover 212 is removed and the battery recharge port 210 of the receiver unit is placed onto the recharge plug 116 on the docking station 110. The collar/receiver assembly 200 is supported on the shelf 118 while the receiver unit is recharging. Once recharging is complete, as visually indicated by the LED 209 on the receiver housing 204, the collar/receiver assembly 200 may be returned to use for containing the pet within the designated area.

Through the incorporation of the collar recharging docking station 110 within the control station 100 itself, user convenience is greatly enhanced as all of the components associated with the electronic pet containment system are centrally located and easily organized. There is no need for multiple AC/DC converter units, as a single unit may be used to efficiently provide both control station power and receiver battery recharging functions.

Alternatively, the receiver batteries may be recharged separately from the docking station using conventional battery recharging units.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A control station for use with a fence-free animal containment system having a perimeter wire defining an area and a receiver within a collar unit worn by a pet, said control station comprising:
a transmitter unit coupled to said perimeter wire for transmitting a signal to the receiver to indicate to the pet when a boundary for said area is proximal; and
a receiver docking station integrated with said transmitter unit for recharging said receiver when the collar unit is not being worn by the pet.

2. The control station as set forth in claim 1, wherein said transmitter unit and said docking station share a common power source.

3. The control station as set forth in claim 1, wherein said transmitter unit and said docking station share a single AC/DC converter.

4. The control station as set forth in claim 1, wherein said docking station includes a battery charge port mounted on a back plate, and a shelf projecting from and generally perpendicular to said back plate for supporting the collar unit when the receiver is coupled to said battery charge port for charging.

5. The control station as set forth in claim 1, wherein said transmitter unit is covered by a housing mounted on a generally vertical back plate having a portion that extends beyond a perimeter of said housing to support said docking station, and said docking station includes a battery charge support arm and a battery charge port electrically coupled to said transmitter unit.

6. The control station as set forth in claim 5, wherein said docking station further includes a shelf projecting from and generally perpendicular to said back plate for supporting the collar unit when the receiver is coupled to said battery charge port for charging.

7. The control station as set forth in claim 6, wherein power to said battery charge port and to said transmitter unit is provided through a single AC/DC converter plugged into a household electrical outlet.

8. A control station for use with a fence-free animal containment system having a perimeter wire defining an area and a receiver within a collar unit worn by a pet, said control station comprising:
a transmitter unit coupled to said perimeter wire for transmitting a signal to the receiver to indicate to the pet when a boundary for said area is proximal, said transmitter unit being covered by a housing mounted on a generally vertical back plate which has a portion extending beyond a perimeter of said housing; and
a docking station associated with said transmitter unit for recharging said receiver when the collar unit is not being worn by the pet, said docking station including,
a battery charge support arm generally parallel with and supported on said back plate portion and having a battery charge port electrically coupled to said transmitter unit; and
a shelf projecting from and generally perpendicular to said back plate for supporting the collar unit when the receiver is coupled to said battery charge port for charging.

9. The control station as set forth in claim 8, wherein said transmitter unit and said docking station share a common power source.

10. The control station as set forth in claim 8, wherein said transmitter unit and said docking station share a common AC/DC converter.

11. The control station as set forth in claim 9, wherein said control station plugs into a household 120V electrical outlet.

12. The combination of a control station for use with a fence-free animal containment system having a perimeter wire defining an area, and a collar/receiver assembly worn by a pet, said combination comprising a transmitter unit within said control station for transmitting a signal through said perimeter wire to indicate to the pet wearing said collar/receiver assembly when a boundary for said area is proximal, a docking station integrated with said transmitter unit for recharging the receiver when the collar of said assembly is not being worn by the pet, said docking station including a shelf and an externally accessed recharging plug electrically connected to said transmitter unit, said receiver having an externally accessed recharge port connectable with the recharging plug of said docking station when said collar/receiver assembly is placed on said shelf for recharging.

13. The combination as set forth in claim 12, wherein said transmitter unit is protected within a housing mounted on a generally vertical back plate that extends beyond a perimeter of said housing, said shelf projecting from and generally perpendicular to said back plate.

14. The combination as set forth in claim 12, wherein said transmitter unit and said docking station share a common power source.

15. The combination as set forth in claim 14, wherein said transmitter unit and said docking station share one AC/DC converter unit.

16. The combination as set forth in claim 12, wherein said control station plugs into a household 120V electrical outlet through an AC/DC converter and said receiver is recharged through said control station using said same AC/DC converter.
